(19) United States
(12) Patent Application Publication
(10) Pub. No.: US 2019/0073179 A1
(43) Pub. Date: Mar. 7, 2019

(54) ELECTRONIC DISPLAY BAND

(71) Applicant: Medea Inc., Pleasanton, CA (US)

(72) Inventors: Brandon S. Laidlaw, Pleasanton, CA (US); Margaret L. Taylor, Incline Village, NV (US); Jed Putterman, Mill Valley, CA (US)

(21) Appl. No.: 16/121,516

(22) Filed: Sep. 4, 2018

Related U.S. Application Data
(60) Provisional application No. 62/554,499, filed on Sep. 5, 2017.
(60) Provisional application No. 62/650,966, filed on Mar. 30, 2018.

(51) Int. Cl. G06F 3/14; G09G 3/14

(52) U.S. Cl. CPC G06F 3/1423; G09G 2370/022; G09G 2370/16; G09G 3/14

(57) ABSTRACT

A electronic display band comprises a circuit board and a plurality of components mounted to the circuit board. The plurality of components comprises one or more battery, one or more integrated circuits, a first plurality of light emitting elements arranged in a grid, a second plurality of light emitting elements and a wireless module. The wireless module comprises a radio, wherein the wireless module is configured to implement a bi-directional wireless mesh network using the radio.

### RELATED APPLICATIONS

This patent application claims the benefit under 35 U.S.C. § 119(e) of U.S. Provisional Application No. 62/554,499, filed Sep. 5, 2017, and further claims the benefit under 35 U.S.C. § 119(e) of U.S. Provisional Application No. 62/650,966, filed Mar. 30, 2018, both of which are herein incorporated by reference.

### TECHNICAL FIELD

Implementations described herein generally relate to electronic devices and more particularly to electronic display bands that can be controlled by mobile computing devices.

### BACKGROUND

Events at large venues such as concerts, sporting events, conventions, and so forth attract large numbers of attendees. Some events are enhanced by having attendees use colored light sticks (also referred to as glow sticks). However, light sticks generally have one or a few static options, and are limited in terms of their display options.

### BRIEF DESCRIPTION OF THE DRAWINGS

Embodiments of present disclosure are illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

Reference will now be made to the accompanying drawings showing examples of the present application, and in which:

FIG. 1A is a diagram depicting a front perspective view of an electronic display band, in accordance with an embodiment of the present disclosure;

FIG. 1B is a diagram depicting a back perspective view of an electronic display band, in accordance with an embodiment of the present disclosure;

FIG. 2 is a diagram depicting wireless propagation of messages to and between electronic display bands, in accordance with an embodiment of the present disclosure;

FIG. 3 is a block diagram depicting an example system architecture for an electronic display band wirelessly connected to a mobile computing device, in accordance with another embodiment of the present disclosure;

FIG. 4 is a flow chart of an embodiment of a method for interfacing with a mobile computing device by an electronic display band;

FIG. 5 is a flow chart of an embodiment for gathering and using information of users associated with electronic display bands;

FIG. 6 illustrates multiple different areas of a mesh network and the distribution of a control message between the areas;

FIG. 7 is a flow chart of an embodiment of a method for synchronizing display of messages and/or light messages between multiple devices in a mesh network; and

FIG. 8 is a block diagram depicting an example computing device, in accordance with an embodiment of the present disclosure.

### DETAILED DESCRIPTION

Described herein are bands such as wrist bands with electronic display devices integrated therein, referred to herein at electronic display bands. The electronic display bands are thin electronic devices that are capable of displaying customized messages and of emitting colored light patterns. In embodiments, the electronic display band runs on a battery and does not have access to frequent charging.

Electronic display bands may form a wireless mesh network, and may propagate control messages to other electronic display bands in the wireless mesh network. A mobile computing device may provide initial control messages to electronic display bands in the wireless mesh network, and those electronic display bands in the wireless mesh network may forward those control messages to other electronic display bands in the wireless mesh network. The control messages may include a text message to display on the electronic display band, a light pattern to display on the electronic display band, and/or an instruction to display a message and/or light pattern already stored on the electronic display band. The electronic display bands may be configured to enable a wireless mesh network with a low latency over a large area (e.g., an area the size of a football stadium).

The electronic display band may not be connected to a network (e.g., may not include a Wi-Fi network adapter or modem), and may rely on another computing device to act as a proxy for communication with a cloud based service. The electronic display band may connect directly or indirectly to the other computing device that acts as a proxy for communication with the cloud based service. For example, the electronic display band may be part of a mesh network (e.g., a Bluetooth mesh network), and one of the members of the mesh network may be the other computing device that acts as the proxy. Accordingly, messages to and from the cloud service may pass through multiple other electronic display bands as well as the computing device that acts as a proxy. The cloud based service may include logic for controlling the electronic display band, granting access to the electronic display band, and so on.

Also described herein are an electronic device controller application that executes on a mobile computing device and an electronic device management service that runs on a server computing device. The electronic device controller application may send command messages to electronic display bands. The command messages may originate on the electronic controller application or may be received from an electronic device management service. The electronic device controller may act as a proxy (e.g., an Internet proxy) for the electronic display band and other electronic display bands, which may not have a capability to access the Internet or remote services.

There are shown in the drawings and will herein be described in detail several specific examples with the understanding that the present disclosure is to be considered as an exemplification of the principles of the described technology and is not intended to limit the technology to the examples illustrated.

The terminology used herein is for the purpose of describing particular embodiments only and is not intended to be limiting of the embodiments of the disclosure. As used herein, the singular forms “a”, “an” and “the” are intended to include the plural forms as well, unless the context clearly indicates otherwise.

It will be understood that like or analogous elements and/or components, referred to herein, may be identified throughout the drawings with like reference characters. It will be further understood that several of the figures are merely schematic representations of embodiments of the present technology.

Embodiments are described herein with reference to electronic display bands that are configured to form a bi-directional wireless mesh network. However, it should be understood that the discussion below with reference to electronic display bands also applies to other types of electronic display devices, such as electronic display tags and electronic display devices attached to containers such as bottles, vases, hats, clothing, and so on. Such other types of electronic display devices may be used instead of electronic display bands, or may be mixed with electronic display bands to form a bi-directional wireless mesh network. For example, a wireless mesh network may include multiple electronic display tags, multiple electronic display bands and/or multiple electronic display devices attached to beverage containers. The other types of electronic display devices may include the same internal components, firmware and/or software programming as discussed herein with reference to electronic display bands, but may have different form factors.

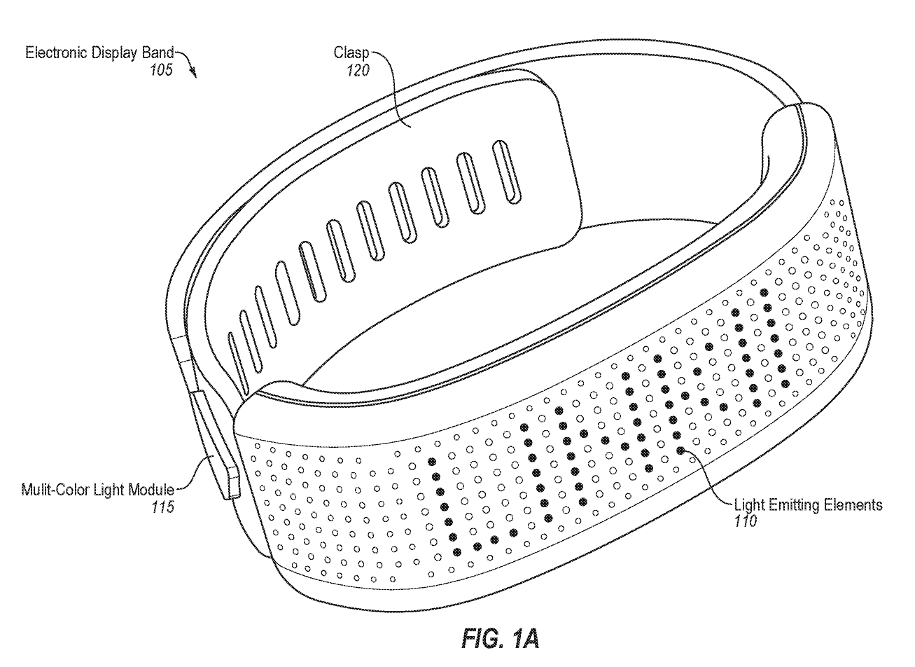

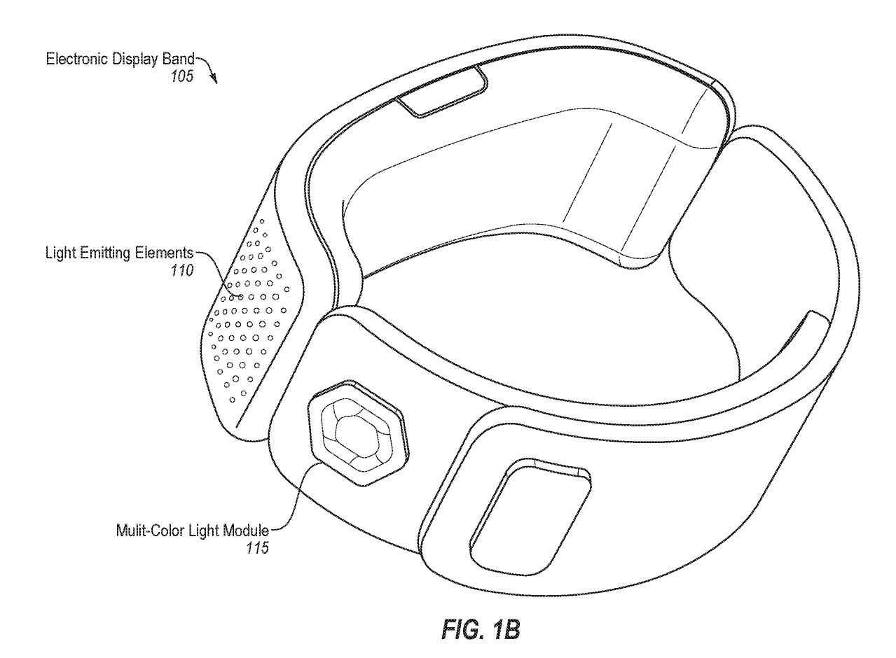

Referring to the figures, FIG. 1A is a diagram depicting a front perspective view of an electronic display band 105, in accordance with an embodiment of the present disclosure. FIG. 1B is a diagram depicting a back perspective view of the electronic display band 105, in accordance with an embodiment of the present disclosure. The electronic display band 105 includes a plurality of light emitting elements 110 such as light emitting diodes (LEDs) that make up a display area. The light emitting elements 110 may be arranged in a grid in embodiments. The electronic display band 105 can be programmed to display a message in the display area. If the message includes more characters than can be displayed, then the message may be displayed as a running or scrolling message. The display area may be capable of displaying text, numbers, shapes, and other images.

The electronic display band 105 additionally includes a multi-color light module 115. The multi-color light module 115 may include one or more light emitting elements (e.g., LEDs) that can singly or together emit many different colors. The multi-color light module 115 may include higher power light emitting elements than the light emitting elements 110 that form the display area and that can display messages. The multi-color light module 115 may emit solid light of various colors, flashing lights, light patterns, and so on. The multi-color light module 115 may vary intensity, timing and/or color of one or more colors of light to provide a near limitless array of light patterns. The multi-color light module 115 may be programmed wirelessly to emit light colors and/or light patterns in a same manner as the display area of light emitting elements may be programmed wirelessly to display messages.

The electronic display band 105 may additionally include a clasp 120 and may be adjustable in size to fit around a user's wrist. The electronic display band 105 may additionally include one or more speakers to output audio (which may also be received wirelessly) and/or may include a microphone to receive voice commands and/or voice inputs.

The electronic display band 105 may include one or more module with active components (e.g., LEDs, processing device, memory, battery, etc.) that are connected to a battery. The module(s) and battery may be enclosed within a material such as a plastic, polymer, rubber, and so on. The material may be flexible or inflexible. The module(s) may include a first wireless module and/or a second wireless module that enables wireless communication with other devices. For example, the module(s) may include a Bluetooth module and/or a low power radio frequency (RF) module.

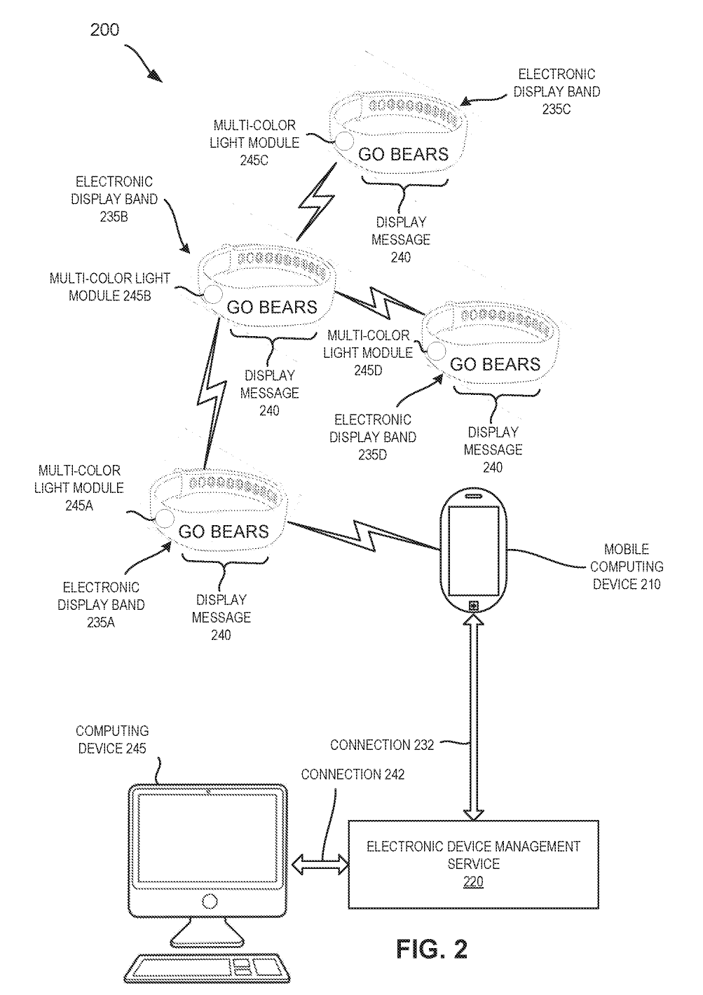

FIG. 2 is a diagram depicting wireless propagation of messages to and between electronic display bands 235A-D, in accordance with an embodiment of the present disclosure. FIG. 2 shows an example system architecture 200 that includes the electronic display bands 235A-D wirelessly connected to a mobile computing device 210, in accordance with an embodiment of the present disclosure. Each of the electronic display bands 235A-D may correspond to electronic display band 105 of FIGS. 1A-B in embodiments.

Electronic display bands 235A-D may each emit low power radio signals. These signals may be used to identify electronic display bands and connect to nearby electronic display bands and form a wireless mesh network. Each electronic display band 235A-D includes one or more wireless module that may periodically broadcast a low power radio signal. The low power radio signal may be broadcast every second, every 2 seconds, every half second, every 20 seconds, or at some other interval. The low power radio signal may be transmitted using a protocol such as Bluetooth low energy (BLE), Bluetooth Mesh or iBeacon, and may include a unique identifier assigned to the electronic display band 235A-D. In one embodiment, the unique identifier includes a universally unique identifier (UUID) that identifies an original equipment manufacturer (OEM) of the electronic display band 235A-D, a first assigned numerical value and a second assigned numerical value. If the iBeacon protocol is used, the low power radio signal includes the UUID, a major and a minor, where the major and minor are each 2 byte values.

A mobile computing device 210 executing an electronic device controller application (not shown) may enter a range of the electronic display band 235A and receive the low power radio signal. The mobile computing device 210 may be a mobile phone, a tablet computer, a laptop computer, a portable game console, a digital camera, or other computing device. The electronic device controller application (App) may be configured for communicating with electronic display bands of the OEM, and may include a user interface that enables a user of the mobile computing device 210 to control such electronic display bands 235A-D.

The mobile computing device 210 may establish and/or maintain a wireless connection with a wireless carrier and/or with a local area network (e.g., via a wireless access point attached to the local area network). Through the wireless connection to the wireless carrier or local area network (LAN), the mobile computing device 210 may establish and/or maintain a connection to an electronic device management service 220. Responsive to receiving the low power radio signal, the mobile computing device 210 may generate a query that includes the received unique identifier (or a portion thereof, such as the major and minor) and information that identifies a user of the mobile computing device. The information that identifies the user of the mobile computing device may be user account information of a user logged into the electronic device controller application. The mobile computing device 210 may also determine its current location (e.g., latitude and longitude) and include the current location in the query. The mobile computing device 210 may then transmit the query to the electronic device management service 220 via the connection 232.

Electronic device management service 220 may process the query to determine whether the user has permission to access the electronic display band and/or to determine whether any actions should be taken. In one embodiment, the electronic device management service 220 determines whether the user has permission to access the electronic display band 235A and sends a response to the mobile computing device 210 indicating whether the user has such permission. If the user has permission to access the electronic display band 235A, then mobile computing device 210 may notify the user of the presence of the electronic display band 235A. Such notification may be performed by displaying an identity (e.g., assigned name) of the electronic display band 235A in a display of the mobile computing device 210, triggering a haptic feedback module, generating an audio alert, and so on.

Once mobile computing device 210 receives notification that the user has access to the electronic display band 235A, mobile computing device may present multiple command options for controlling the electronic display band 235A via the user interface of the electronic device controller application. Such command options may include options to generate a message, send the message to the electronic display band 235A, cause the electronic display band to display the message or another message already stored on the electronic display band, receive a battery level indication from the electronic display device, remotely power down the electronic display band 235A, and so on. Mobile computing device 210 may additionally establish a wireless connection 230 (e.g., using a bidirectional wireless communication protocol such as Bluetooth), and may send data such as commands and/or messages to the electronic display band 235A via the wireless connection 230. For example, a user may type in the display message 240 “GO BEARS” via the user interface and may then send the display message 240 to the electronic display band 235A for display thereon.

In addition to receiving information about electronic display band 235A from electronic display band 235A, mobile computing device 210 may also receive information about electronic display band 235B, electronic display band 235C, electronic display band 235D and/or other electronic display bands. The information about the various electronic display bands 235A-D may be sent through the electronic display band 235A to the mobile computing device 210, for example. Accordingly, the mobile computing device 210 may receive information about many mobile display bands at a location. In embodiments, mobile computing device 210 may receive information about tens, hundreds, thousands, or even tens of thousands of electronic display bands. Mobile computing device 210 may then forward the information on to electronic device management service 220. Mobile computing device 210 may view a list of those electronic display bands 235A-D that an account associated with the mobile computing device 210 has access to in embodiments.

A mesh protocol such as Bluetooth Mesh may be used by the various electronic display bands 235A-D. Electronic display bands 235C and 235D may connect to electronic display band 235B via the mesh network protocol, and may transfer their UUIDs to electronic display band 235B. Similarly, electronic display band 235B may connect with electronic display band 235A via the mesh network protocol, and may send to electronic display band 235A the UUID of electronic display band 235B and the UUID of electronic display bands 235C and 235D. Electronic display band 235A may therefore communicate to mobile computing device 220 the UUIDs of each of electronic display bands 235A-D, which mobile computing device 220 may forward to electronic device management service 220.

Electronic device management service 220 may include user accounts associated with each of the electronic display bands 235A-D. Each user account may include information such as a user name, age, gender, interests, and so on. Additionally, electronic device management service 220 may update a location for each of the user accounts based on a location of mobile computing device 220. Additionally, electronic device management service 220 may determine an IP address associated with electronic display bands and add the current IP address to the user account.

Electronic device management service 220 may generate a message (e.g., GO BEARS) to send to each of the electronic display bands 235A-D. These electronic display bands 235A-D may be associated with different user accounts and owned by different users. However, when the electronic display bands 235A-D are collocated at a location, they may form a group, and may be messaged and/or controlled as a group. Accordingly, mobile computing device 220 may send the “GO BEARS” message to electronic display band 235A, which may display message 240, and which may also forward the message to electronic display band 235B. Electronic display band 235B may display message 240, and may also forward the message to electronic display bands 235C-D, which may also display message 240.

Additionally, or alternatively, electronic device management service 220 may generate an instruction to display a particular light color or light pattern. The electronic device management service 220 may send the instruction to mobile computing device 210, which may forward the instruction on to electronic display band 235A. Electronic display band 235A may process the instruction to emit the light color and/or light pattern using multi-color light module 245A. Additionally, electronic display band 235A may forward the instruction to electronic display band 235B. Electronic display band 235B may process the instruction to emit the light color and/or light pattern using multi-color light module 245B. Additionally, electronic display band 235B may forward the instruction to electronic display bands 235C-D, which may also emit the light colors and/or patterns using multi-color light module 245C-D.

In addition to sending the same message and/or instruction to all of the electronic display bands 235A-C in an area, electronic device management service 220 may generate different messages for display on each of the electronic display bands and/or on various sub-groups of electronic display bands. Electronic display bands 235A-D may be grouped into one or more groups in a hierarchy of groups. The electronic device management service 220 may maintain a hierarchy of groups, which may include many different levels of groups. For example, electronic display bands may be grouped based on city, venue, zone within a venue, sub-zone within a venue, latitude and longitude, and so on. A master controller operating computing device 245 or mobile computing device 210 may be able to generate a message and/or instruction directed at every electronic display band included in a particular zone at a particular venue, in a particular city. Each electronic display band 235A-D may include in its configuration an assignment to one or more groups in the hierarchy of groups. Mobile computing device 210 may broadcast the message and/or instruction (or otherwise send the message and/or instruction via the wireless mesh network), and the message and/or instruction may eventually be received by each of the electronic display bands 235A-D. Each electronic display band 235A-D, on receiving the message and/or instruction, may determine whether that receiving electronic display band 235A-D is within the groups that are to display the message and/or emit a particular light color and/or pattern. Each electronic display band 235A-D may additionally determine whether to broadcast the message and/or instruction. The message and/or instruction may propagate through large areas (e.g., such as venues the size of a football stadium) in less than 100 milliseconds in embodiments.

Each message and/or instruction generated by electronic device management service 220 or mobile computing device 210 may include a destination device and/or a destination group. A recipient device may receive the message, check if it is the destination device and/or in the destination group, and then forward it on to one or more next devices. Accordingly, the message will eventually reach the destination device and/or group. In some embodiments, the messages have a time associated with them such that they will be displayed at a particular time. This may enable each of the electronic display bands 235A-D to display a message together as a group, even if it takes longer for some of the devices to receive the message. Other synchronization schemes are also discussed herein below. Messages can indicate text and/or images to display, colors to display, sounds to play, and so on.

In one embodiment, the electronic display band 235A may be owned by the user of mobile computing device 210, but electronic display band 235B-D may have different ownership. Responsive to electronic device management service 220 receiving the query from mobile computing device 210, electronic device management service 220 may determine owners of the electronic display bands 235A-D, and may send a notification to those users (e.g., via email, text message, etc.). The notification may indicate a location (e.g., an IP address) of the electronic display band. Alternatively, electronic device management service 220 may log the query, and the owner may use a computing device 245 to connect to the electronic device management service 220 (e.g., via a Web browser), and may view the log.

Mobile computing device 220 may be able to view and control one or more of electronic display bands 235A-D. However, mobile computing device 220 may not be able to view and/or control electronic display bands 235B-D if they have different ownership. Alternatively, if electronic display band 235B was owned by the user of mobile computing device 220, but electronic display band 235A was not, then mobile computing device 220 may be able to view and control electronic display band 235B but not electronic display band 235A, even though mobile computing device is directly connected to electronic display band 235A and only indirectly connected to electronic display band 235B. In some embodiments, such as where mobile computing device 210 has master privileges, mobile computing device 210 may be able to control all of the electronic display bands 235A-D.

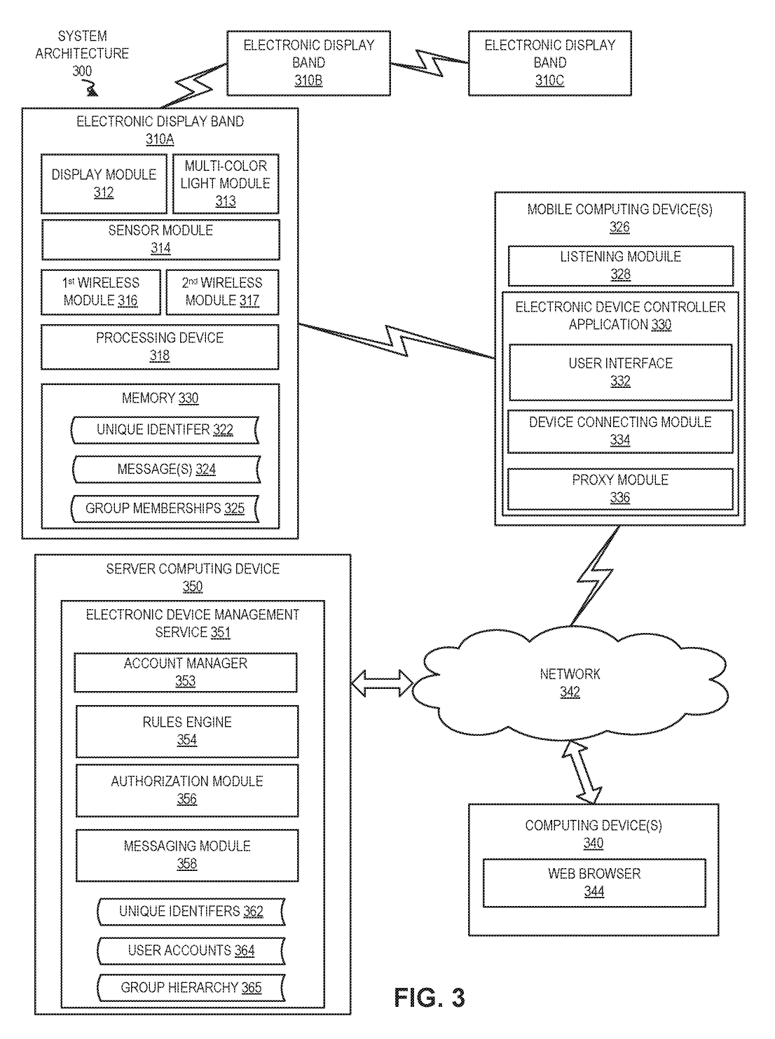

FIG. 3 is a block diagram depicting an example system architecture 300 including an electronic display band 310A, one or more computing devices 326, and a server computing device 350. Also shown are additional electronic display bands 310B-C. In one embodiment, system architecture 300 corresponds to system architecture 200 of FIG. 2. Electronic display band 310A may be communicably coupled to the one or more mobile computing devices 326 via wireless connections. As discussed above, these wireless connections (e.g., Bluetooth connections) may be established responsive to server computing device 350 determining that the mobile computing devices 326 have permission to access the electronic display band 310A. Alternatively, these wireless connections may be established regardless of ownership. For example, wireless connections may be established to form a mesh network of devices at a venue, where different devices may belong to different users.

Electronic display band 310A may include a display module 312, a multi-color light module 313, a sensor module 314, a first wireless module 316, a second wireless module 317, a processing device 318, a memory 320, and/or other hardware, firmware and/or software modules. One or more of the modules, processing device and/or memory may be an integrated circuit. Memory 320 may store an assigned unique identifier 322 that identifies an OEM associated with the electronic display band and uniquely identifies the electronic display band 310A of that OEM. Memory 320 may additionally store a group hierarchy, and group memberships 325 of the electronic display band 310A to groups in one or more levels of the group hierarchy. Electronic display band 310A may belong to any number of groups in any number of layers in a group hierarchy. Memory 320 may additionally store one or more messages 324 that may be displayed by display module 312 and/or one or more light colors and/or light patterns that may be emitted by the multi-color light module 313. In one embodiment, memory 320 also stores a password. In one embodiment, one or more of the wireless module 316, processing device 316 and/or memory 320 are components of a system on a chip (SoC).

Display module 312 may include an electronic visual display that may be illuminated to display an image or alphanumeric message. Display module 312 may include a grid of light emitting elements. Each light emitting element may be or include light emitting diodes (LEDs), organic light emitting diodes (OLEDs), liquid crystal display (LCD), or elements of other similar display technology. The image or alphanumeric message displayed by the display module 312 may be static or may be displayed in a manner that appears to show movement (e.g., motion picture or scrolling text). Display module 312 may have a variety of sizes and include pixels of various colors.

In one example, display module 312 may be used for advertising or displaying various images or messages, such as greetings, calendar events (e.g., birthdays, anniversaries, holiday messages, events of cultural significance), etc. Optionally, the display module 312 may utilize animated images or messages. For example, messages may scroll from any direction, strobe, glow, etc. The messages or images may allow the electronic display bands to serve as an advertising or marketing channel. The marketing channel may allow for multiple levels of distribution (e.g., directly to customers, through a distributor, etc.). A customizable communication or message allows for maximum flexibility.

Multi-color light module 313 includes one or more additional light emitting elements. The light emitting elements of multi-color light module 313 may be larger and more powerful than the light emitting elements of display module 312. Additionally, the light emitting elements of multi-color light module 313 may not be arranged in a grid pattern. The light emitting elements of multi-color light module 313 may be or include light emitting diodes (LEDs), organic light emitting diodes (OLEDs), liquid crystal display (LCD), or elements of other similar display technology. Multi-color light module 313 may be configured to emit colored light in any one of multiple different colors (e.g., may include red-green-blue (RGB) LEDs). Multi-color light module 313 may additionally be configured to emit light patterns (e.g., flash a single color on and off, alternate between flashes of different colors, and so on). Additionally, the light emitting elements of multi-color light module 313 may be arranged in a circular or radial pattern, and the light emitting elements may be powered on and off using different colors in a manner that causes a moving light pattern.

Sensor module 314 may include one or more sensor devices for gathering data associated with the electronic display band 310A-C. The sensor devices may include audio sensors (e.g., microphones), motion sensors (e.g., accelerometer, gyroscope, etc.), light sensors (e.g., ambient light sensor), location sensors (e.g., global positioning system sensors (GPS)), temperature sensors (e.g., thermometer), or other similar sensing devices. Data generated by sensor module 314 may be forwarded by mobile computing devices 326 to server computing device 350 for processing. For example, an audio signal may be sent to server computing device 350 to perform speech to text processing.

First wireless module 316 and/or second wireless module 317 may enable electronic display band 310A to receive and transmit messages and commands. First wireless module 316 and/or second wireless module 317 may include a radio (e.g., a transmitter, receiver, transceiver, antenna, etc.), a memory, and so forth for communicating with a computing device (e.g., with mobile computing devices 326). In one embodiment, first wireless module 316 includes a Bluetooth wireless adapter capable of communicating using multiple different Bluetooth based protocols (e.g., iBeacon, low energy Bluetooth, Bluetooth Mesh, Bluetooth, etc.). The first wireless module 316 may include a single radio (e.g., with a single antenna) that may both send and receive data simultaneously using a first frequency band to send data and a second frequency band to receive data. The first wireless module 316 may hop between a preset number (e.g., three) of frequency bands for the sending and receiving of data. In one embodiment, second wireless module 317 may include a wireless adapter that uses protocols for Near Field Communication (NFC), Wi-Fi®, infrared (IR), Linux® wireless, Zigbee®, or any other low frequency RF modulation protocol. In one embodiment, electronic display band 310A includes only a single wireless module. In one embodiment, the single wireless module is a Bluetooth radio. In one embodiment, the single wireless module includes a Bluetooth radio and an RF radio.

First wireless module 316 may be used to initiate or establish wireless connections to mobile computing devices 326 and/or to other electronic display bands 310B, 310C. The connections may include direct connections and indirect connections. Direct connections may directly connect electronic display band 310A with a mobile computing device 326 and may not use any intermediate electronic display bands to forward messages. Indirect connections may rely on one or more intermediate electronic display bands to forward messages.

In one embodiment, first wireless module 316 is configured to form a wireless mesh network with mobile computing devices 326 and/or the wireless modules of other electronic display bands (e.g., electronic display bands 310B-C). The wireless mesh network may be a bi-directional mesh network implemented using Bluetooth Mesh. Bluetooth Mesh networking uses Bluetooth Low Energy (LE) as the protocol stack to send and receive messages. However, Bluetooth Mesh is designed to accommodate at most a few hundred to thousand devices located within a relatively small area such as a household. In contrast, in embodiments first wireless module 316 is configured to implement Bluetooth Mesh with up to tens of thousands or hundreds of thousands of devices in large areas (e.g., having a size of up to a football stadium). A single electronic display band 310A may communicate directly with thousands of other devices (e.g., electronic display bands and/or mobile computing devices) with minimal delay in a manner that enables the devices to display messages (e.g., text messages) and/or light patterns synchronously. Accordingly, the first wireless module 316 is implemented to send messages using a one-to-many and/or many-to-many relationship, where many may be up to thousands of devices.

The first wireless module 316 (and first wireless modules of the other electronic display bands) are configured to ensure 100% delivery of messages to all electronic display bands in an area in a time scale of under 100 milliseconds from the time that a first message is sent to a time when the very last electronic display band in the mesh network receives the message. In embodiments, the first wireless module 316 is configured to make decisions regarding whether to forward data (e.g., messages and/or commands) within the mesh network based on one or more of a number of hops that the data has traveled, how long it has been since the data was generated, a time of flight for the data, and so on.

In one embodiment, electronic display band 310A includes a single Bluetooth radio. For example, a single Bluetooth radio may be included in first wireless module 316 and/or connected to first wireless module 316. The single Bluetooth radio may be used to communicate with mobile computing device(s) 326 as well as one or more other electronic display bands (e.g., electronic display bands 310B-C). The single Bluetooth radio may hop between three different frequency bands for sending and receiving data. In one embodiment, the Bluetooth radio sends and receives data concurrently using different frequencies. For example, the Bluetooth radio may receive data from mobile computing device 326 at a first frequency and may concurrently send the same data or other data to electronic display band 310B at a second frequency.

In one embodiment, the electronic display band 310A includes one or two buttons usable for basic control of the electronic display band 310A. The buttons may include a power button, which may be used to turn on and off the electronic display band. In one embodiment, the power button is usable to toggle through different modes of operation for the electronic display band 310A. The modes of operation may include an unpowered mode, a sleep mode in which most of the components of the low power electronic display are unpowered (e.g., in which no radio signals are broadcast and a display is disabled), a display state in which a message is displayed by the display module 312 and the wireless module periodically transmits a low power radio signal, and/or a broadcast mode in which the display module 312 and/or multi-color light module 313 are unpowered but the first wireless module 316 broadcasts the low power radio signal at an interval.

Mobile computing devices 326 may be any portable devices capable of communicating with electronic display band 310A that include an electronic device controller application 330 installed thereon. Examples include smart phones, tablet computers, laptops, etc.

Mobile computing devices 326 may include a listening module 328 and the electronic device controller 330. Listening module 328 may run in a background of mobile computing devices 326 and may listen for low energy radio signals that include a unique identifier 322 of any electronic display band 310A-C manufactured by a particular OEM. Such low energy radio signals may be short range signals that are periodically broadcast by the first wireless module 316. Responsive to receiving such a low energy radio signal, listening module 328 may load electronic device controller application 330. Alternatively, listening module 328 may perform other operations such as generate a query and send the query to the server computing device 350.

In one embodiment, electronic device controller application 330 is a program (e.g., an App) that runs on mobile computing devices 326. In one example, electronic device controller application 330 may be a downloadable application for a mobile device. For example, mobile devices may include Android®, iPhone®, or Blackberry® devices capable of running a software application (e.g., Android Smart Bottle software App, iPhone Smart Bottle software App, Blackberry Smart Bottle software App, etc.). Alternatively, electronic device controller application 330 may be firmware and/or a hardware logic on a mobile computing device 326. Electronic device controller application 330 may act both as a controller for electronic display bands (which may lack their own user interfaces) and as a proxy for providing network connectivity (e.g., an Internet connection) to the electronic display bands 310. In one embodiment, electronic device controller application 330 includes a user interface 332, a device connecting module 334 and a proxy module 336.

Proxy module 336 communicates with electronic device management service 351 on behalf of electronic display bands 310A-C. Proxy module 336 may establish a connection to electronic device management service 351 on server computing device 350 via network 342. Network 342 may include a public network (e.g., the Internet), a private network (e.g., a local area network (LAN) or wide area network (WAN)), or a combination thereof. Network 342 may also include a wired network (e.g., Ethernet network), a wireless network (e.g., an 802.11 network or a Wi-Fi network), a cellular network (e.g., a Long Term Evolution (LTE) network), or combination thereof, and may include a wireless access point, network routers, switches or other similar network devices.

Responsive to mobile computing device 326 receiving data from electronic display band 310A (e.g., a unique identifier received in a low energy radio signal), proxy module 336 may forward that data to server computing device 350 for processing by electronic device management service 351. The received data may be data about electronic display band 310A, data about electronic display band 310B and/or data about electronic display band 310C. Proxy module 336 may generate queries and/or other messages for electronic device management service 351, which may include the data received from the electronic display band 310A as well as other data generated or received by mobile computing device 326. Data from the electronic display band 310A may include unique identifiers assigned to each of the electronic display bands 310A-C, battery states of the electronic display bands 310A-C, messages stored on the electronic display bands 310A-C, group memberships of the electronic display bands 310A-C, acceleration data, speech data, rotational data, proximity sensor data, light sensor data, temperature data, and so on. Data from the mobile computing device 326 may include location data (e.g., a geo location, an IP address, etc.), user account data, date and time, signal strength data (e.g., of the low energy radio signal received from the electronic display band 310A), and so on.

Electronic device management service 351 may include a rules engine 354 (discussed further below) that processes received data to determine whether any actions are to be taken. Proxy module 336 may then receive a response message from the electronic device management service 351 based on an output of the rules engine 354. For example, proxy module 336 may receive an indication as to whether the user of the mobile computing device has permission to access any of the electronic display bands 310A-C. Proxy module 336 may additionally receive messages to be displayed to the user via user interface 332 and/or instructions to send messages and/or commands to the electronic display band 310A (which may or may not be forwarded by electronic display band 310A to the other electronic display bands 310B-C). Such messages and/or instructions may be sent to the electronic display band 310A whether or not the user has access to the electronic display band. For example, if the user does not have access to the electronic display band 310A, then such messages and/or commands may be sent to the electronic display band without notifying the user of the mobile computing device of the presence of the electronic display band or the fact that the mobile computing device 326 is communicating with the electronic display band 310.

User interface 332 may act as a remote user interface for electronic display bands 310A-C. User interface 332 may be a graphical user interface or a command line user interface. If a user of the mobile computing device 326 has access to any of the electronic display bands 310A-C (e.g., as decided by electronic device management service 351), then the user interface may display a presence of those electronic display bands 310A-C as well as command options for controlling the electronic display bands 310A-C.

One example command option includes a command to generate a new message and/or light pattern and/or send the new message and/or light pattern to an electronic display band 310A-C. If a user selects a generate message option, user interface 332 may present a virtual keyboard with alphanumeric characters that the user may type on to create a new message. If a user selects a generate light pattern option, user interface 332 may present an interface for designing light patterns.

Alternatively, a user may speak into a microphone of the mobile computing device 326, and electronic device controller application 330 may generate an audio file and transmit the audio file to electronic device management service 351 or a separate transcription service to translate the speech into text. The text may then be sent back to the mobile computing device 326 and used for the message. Alternatively the mobile computing device 326 may include a local transcription module that translates speech to text for a new message. Once the new message is created, the user may select a set message command option and select one or more electronic display bands to send the message to.

Other command options include a display message command, a report messages command, an emit light pattern command, a set unique identifier command, a disable display command, a read battery level command, a read display state command, a change broadcast rate command, and so on. The display message command causes a selected electronic display band 310A-C (or multiple electronic display bands) to display a selected message, which may already be stored on the electronic display band or may be sent to the electronic display bands for display.

Any command and/or message may be directed to a single electronic display band 310A-C or to one or more groups of electronic display bands 310A-C. For example, the display message command and/or associated message may be directed to a particular group and/or a particular electronic display band within a group hierarchy. For example, the display message command may be directed to devices belonging to a regional group (e.g., CA), a sub-regional group (e.g., San Francisco), a venue group (e.g., Giants Stadium), and a zone group (e.g., zone A). The mobile computing device 326 may send the display message command to electronic display band 310A, which may determine based on its group memberships 325 whether the display message command is directed to it. If the electronic display band 310A is included in the group to which the display message command is directed, then electronic display band 310A may display a particular message. If the electronic display band 310A is not in the group, then the electronic display band 310A may not display the message. In either case, the electronic display band 310A may use the mesh network that was joined by first wireless module 316 to deliver the display message command to many other electronic display bands (e.g., to electronic display bands 310B-C). Each electronic display band may then make its own decision as to whether that electronic display band should display the message and/or whether that electronic display band should forward the display message command. Commands to emit light patterns may be propagated in a similar manner. Alternatively, commands to emit light patterns may be propagated using a low energy RF protocol other than Bluetooth. For example, messages and commands or signals to emit light colors and/or light patterns may be propagated using a proprietary low energy RF protocol. All of the electronic display bands and/or groups of electronic display bands at a particular venue are able to display messages and/or light patterns together (e.g., in a synchronized manner) in embodiments.

The set unique identifier command changes a value of a unique identifier assigned to an electronic display band. Electronic display bands may be manufactured with a default identifier, and that identifier may be replaced with a unique identifier after the electronic display band is powered on by a user for a first time. In one embodiment, the unique identifier is a pair of integers (e.g., a major and a minor as defined by the iBeacon protocol). These numerical values in one embodiment are each 3 byte values. The two numerical values may be combined to create a single larger numerical value (e.g., a 4 byte numerical value). By combining, for example, two independent 3 byte values, each of which has 65,536 possible unique values into a single unique 4 byte value, the number of possible unique values is increased many times to 4,294,967,296 possible values.

The report messages command may cause an electronic display band to notify the electronic device controller 330 of all messages currently stored on the electronic display band. The electronic display band may broadcast a low energy radio signal on a periodic basis to notify nearby mobile devices of its identity. The change broadcast rate command may be used to adjust the frequency at which the low power radio signal is broadcast. A less frequent broadcast may improve a battery life of the electronic display band.

Device connecting module 334 is responsible for establishing wireless connections to electronic display bands (e.g., to electronic display band 310A). In one embodiment, device connecting module 334 establishes a direct bidirectional peer-to-peer connection to the electronic display band (e.g., a Bluetooth connection). In one embodiment, device connecting module 334 joins a mesh network (e.g., a Bluetooth Mesh network) including multiple electronic display bands 310A-C.

Server computing device 350 may be a desktop computer, rackmount server, blade server, or other physical machine used to host a server. Server computing device 350 hosts electronic device management service 351. In one embodiment, server computing device 350 includes a virtual machine monitor (also referred to as a hypervisor) that hosts virtual machines, and the electronic device management service is a service that executes in a virtual machine hosted by the server computing device 350. For example, electronic device management service 351 may be a cloud based service that is hosted by Amazon's® Elastic Compute Cloud (EC2).

Electronic device management service 351 is a service for managing the interaction with electronic display bands and/or other electronic devices. Electronic device management service 351 may include a rules engine 354, an authorization module 356 and/or a messaging module 358. Alternatively, the functionality of one or more of the rules engine 354, authorization module 356 and/or messaging module may be combined into a single module or divided into additional modules.

Authorization module 356 is responsible for determining whether a user of a mobile computing device 326 is authorized to access an electronic display band. Electronic device management service 351 may receive a query from a mobile computing device 326 (e.g., from a proxy module 336), the query including a unique identifier of an electronic display band and user account information of a user of the mobile computing device. Authorization module 356 may perform a lookup on the user account and the unique identifier, which may be stored in a data structure (e.g., a database, table, etc.) including assigned unique identifiers 362 and user accounts 364. A user may have access to an electronic display band if that user owns the device or if access to the device has been shared with the user (e.g., by the owner) or if that user has a master control status (e.g., for a venue). If the user account has access to the electronic display band associated with the received unique identifier, then messaging module 358 sends a response message back to the mobile computing device 326 indicating that the user has access permissions. Otherwise the messaging module 358 may send a response indicating that the user does not have such access permissions.

In some instances an electronic display band may have a default unique identifier, and may not be associated with any user account. When a query that includes such a default identifier is received, authorization module 356 may determine an unused unique identifier, and may assign that unused unique identifier to the electronic display band. Authorization module 356 may generate an ownership record for the user account associated with the received query, where the ownership record includes the unique identifier. Messaging module 358 may transmit a response to the mobile computing device 326 from which the query was received, where the response includes the assigned unique identifier. The response may also include an instruction to program the electronic display band to have the unique identifier. The electronic device controller application 330 of the device connecting module 334 may then connect to the electronic display band (if a connection has not already been established), and may send an instruction to the electronic display band to overwrite the default identifier with the assigned unique identifier.

Data from received queries may also be input into rules engine 354. Rules engine 354 may include one or more rules, and may apply these rules to generate commands, perform actions, generate light patterns, and/or generate messages based on received data. Actions that are performed may include sending messages and/or notifications to specific users (e.g., to owners), sending messages to mobile computing devices for presentation thereon, sending commands to mobile computing devices that cause them to connect to electronic display bands and send or forward commands to those electronic display bands (e.g., to display a message on a electronic display band), and so on. In one embodiment, authorization module 356 is a component of rules engine 354, and is implemented via an authorization rule and/or a new device rule. Rules engine 354 may include any number of rules, which may be used to perform many different actions.

As discussed above, in some instances electronic display bands may be logically divided into one or more groups, and a user may select a group to send a message and/or command to. A user with access to multiple electronic devices may generate any desired groupings and/or hierarchical structure of groupings for controlling the electronic devices. This enables the user to easily select a set of electronic devices and perform the same action with regards to each of these electronic devices. For example, a user may generate a top level group for all of the electronic devices in a store, and different second level groups for each floor of the store. The user may then select the top level group to select all electronic devices in the store, or one of the second level groups to select all of the electronic devices on one of the floors. In one embodiment, electronic display bands are automatically grouped based on location. The electronic display bands that are within range of one another may connect directly or indirectly using a mesh protocol (e.g., Bluetooth mesh), and may set up a group based on their proximity.

In one embodiment, electronic device management service 351 includes an account manager 353. When a user installs the electronic device controller application 330 on their mobile computing device and/or otherwise sets up a user account, account manager 353 may be invoked. Account manager 353 receives user information, generates a user account, and assigns the user information to the user account. Account manager 353 may additionally assign a UUID for a electronic display band owned by the user to the user account. In one embodiment, a user inputs an email address, and through the email address account manager 353 retrieves user information such as name, age, gender, and so on. Alternatively, or additionally, a social network service account may be provided by a user and tied to the user account. This may provide much additional information about the user.

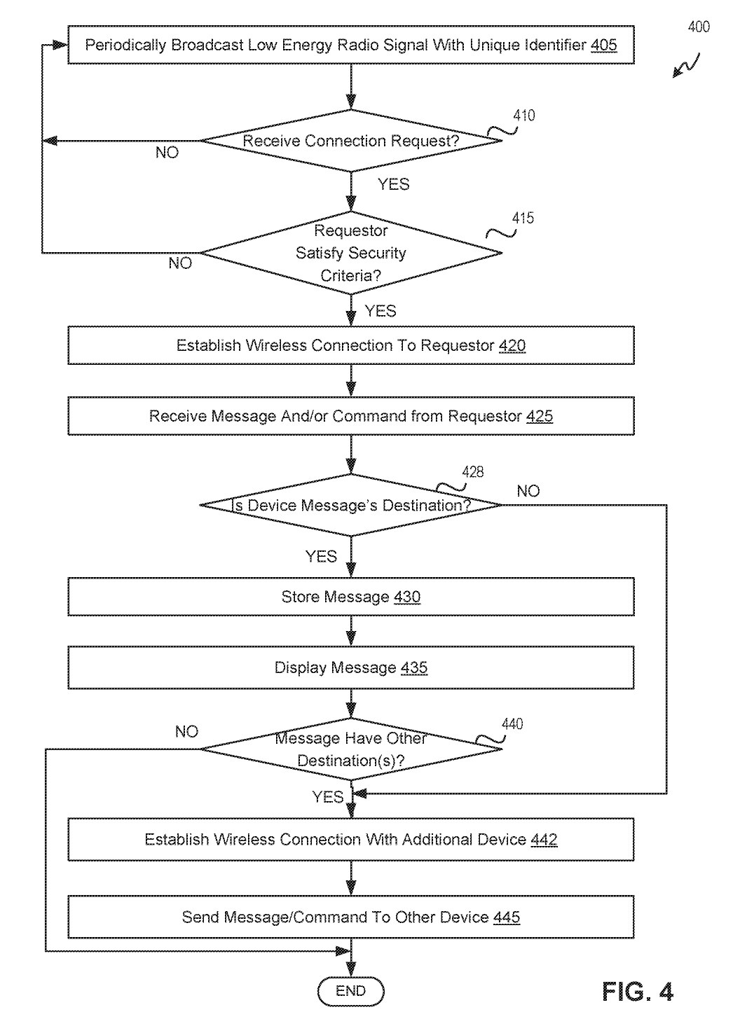

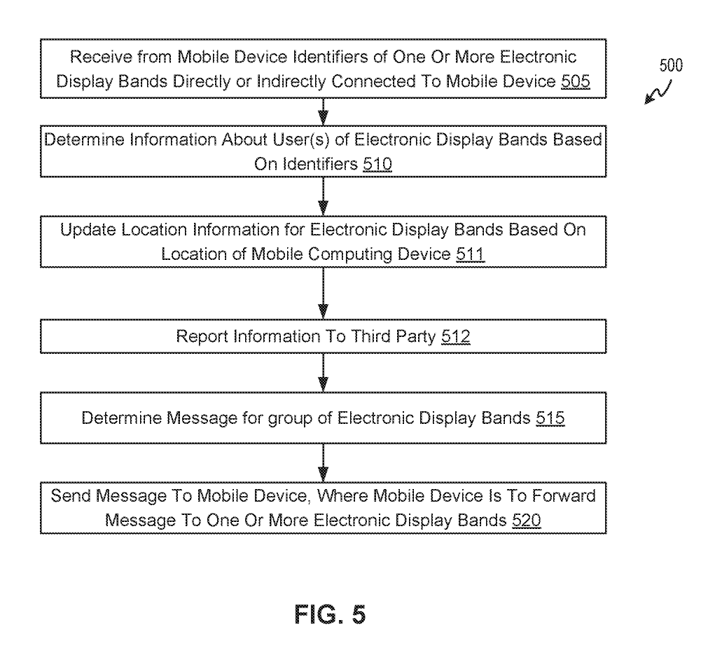

FIGS. 4-5 depict flow charts of multiple illustrative examples of methods 400, 500 for controlling one or more electronic display bands using a mobile phone (or other mobile computing device) and/or remote server. The methods and each of their individual functions, routines, subroutines, or operations may be performed by processing logic of an electronic display band, mobile computing device, or server computing device executing the method. The processing logic may include hardware, software, firmware, or a combination thereof. For example, processing logic may include a general purpose and/or special purpose processor that executes instructions for performing the methods.

Referring to FIG. 4, at block 405 of method 400 processing logic of an electronic display band periodically broadcasts a low energy radio signal that includes a unique identifier. The periodic broadcast may be generated in accordance with a first wireless protocol, such as a Bluetooth low energy (BLE) protocol, a Bluetooth Mesh protocol and/or the iBeacon protocol. At block 410, processing logic determines whether a connection request has been received. The connection request may be a request from another electronic display band or from a mobile computing device (e.g., a mobile phone). If a connection request is received, the method continues to block 415. Otherwise, the method returns to block 405.

At block 415, processing logic determines whether a requestor of the connection satisfies one or more security criteria. If the connection request matches a security criterion, the method continues to block 420. Otherwise, the method returns to block 405.

At block 420, processing logic establishes a wireless connection to the requestor. This wireless connection may be established in accordance with the wireless protocol or with a second wireless protocol. In one embodiment, the wireless connection is a bidirectional peer-to-peer Bluetooth connection established in accordance with the Bluetooth protocol. In one embodiment, the connection is a Bluetooth Mesh connection.

At block 425, processing logic receives a message from the requestor. The message may be a message generated by the requestor, or a message that was forwarded to the requestor by another device, which may be another electronic display band or a mobile computing device.

At block 428, processing logic determines whether the electronic display band of the processing logic is the message's destination. If so, the method proceeds to block 430 and processing logic stores the message. At block 435, processing logic may display the message. In one embodiment, the message is displayed responsive to an additional command from the requestor to display the message. If the electronic display band of processing logic is not the destination, then the method continues to block 442.

At block 440, processing logic determines whether the message also has an additional destination. For example, the message may have indicated two devices to receive the message. Alternatively, or additionally, the message may have indicated a group of devices to receive the message. If the message had no additional destinations, then the method ends. If the message had one or more additional destinations, then the method proceeds to block 442.

At block 442, processing logic establishes a wireless connection with one or more additional device (e.g., to one or more additional electronic display bands using the Bluetooth Mesh protocol). Alternatively, such a connection may already have been established (e.g., via a mesh network). At block 445, processing logic sends the message to the other device. In one embodiment, processing logic synchronizes the electronic display band comprising the processing logic to one or more nearby electronic display bands. Once the devices are synchronized, they may perform operations together as a group, such as display the same message at the same time, blink on and off or between a pattern of colors together, and so on.

FIG. 5 is a flow chart of an embodiment for a method 500 of gathering and using information of users associated with electronic display bands. At block 505 of method 500, processing logic receives from a mobile device identifiers (e.g., UUIDs) of one or more electronic display bands directly or indirectly connected to the mobile device. A first one of the electronic display bands will be directly connected to the mobile computing device. One or more of the other electronic display bands may be connected to the first electronic display band and/or one or more other intermediate electronic display bands, and through the first electronic display device and/or one or more other intermediate electronic display bands to the mobile computing device.

At block 510, processing logic determines information about users of the electronic display bands based on the received identifiers. Each identifier may be associated with a particular user account, which may include user information. Accordingly, the identifiers (e.g., UUIDs) may be used to look up one or more user accounts, and the user accounts may indicate user information. At block 511, processing logic updates a location of each of the identified electronic display bands based on a location of the mobile computing device. This location information may include an internet protocol (IP) address and/or a geo location. The location of the mobile computing device may have been provided by the mobile computing device along with or separate from the identifiers. At block 512, processing logic may report information such as user information of the users associated with the detected electronic display bands to a third party. For example, the electronic display bands may be wristbands worn by people attending a concert. The third party may be an owner of the venue. Accordingly, the owner of the venue may receive information regarding the crowd at their establishment.

At block 515, processing logic determines a message for a group of electronic display bands. The group of electronic display bands may be at a particular venue, for example. These devices may be synchronized together via a mesh protocol such as the Bluetooth Mesh protocol. At block 520, processing logic sends the message to the mobile device. The mobile device may then forward the message to at least one electronic display band to which it is wirelessly connected. That electronic display band may then forward the message to one or more additional electronic display bands, which in turn may forward the message to still other electronic display bands, and so on. All of the electronic display bands may then display the message. Additionally, a command to emit a particular light color and/or light pattern may be sent to the mobile device. The mobile device may then send the command to emit the particular light color and/or light pattern to one or more electronic display bands, which may optionally forward the command on to other electronic display bands. All of the electronic display bands may then emit the light color and/or light pattern in a synchronized fashion.

In one embodiment, processing logic generates multiple messages and/or commands, each of the messages and/or commands having a different destination group. The electronic display bands at a location may be divided into multiple groups, and a different message and/or command may be assigned for each of the groups. This may enable to electronic display bands to light up and/or display messages and/or light patterns based on their group membership.

As set forth above, in embodiments the electronic display bands described herein provide a unique implementation bi-directional wireless mesh network to exchange commands and/or messages that cause one or a group of electronic display bands to display messages and/or emit light colors and/or light patterns together. The bi-directional wireless mesh network may ensure that many electronic display bands, which may be separated by hundreds of meters or more, display messages and/or light patterns together in a synchronized manner in embodiments. In contrast, existing mesh network solutions would cause lag between message and/or light displays between devices, causing the devices to lack synchronization.

One example implementation of the bi-directional wireless mesh network is set forth below, in accordance with embodiments of the present disclosure. The structure of control messages used for controlling the electronic display bands (or other electronic display devices) from a single source device is provided in the example. In embodiments, the messages may be sent over Bluetooth low energy (BLE). Control messages may be BLE advertising messages in embodiments. Control messages may be sent over two of three available advertising channels provided by the BLE protocol in embodiments. A source device (e.g., a device generating a control message) should advertise only on the two first channels of the three available BLE channels in some embodiments.

A control message may originate from a single source device, which may act as the entry point of new control messages into the bi-directional wireless mesh network composed of multiple electronic display bands. For example, the control message may be generated by an application (app) on a mobile computing device such as a mobile phone, a tablet computer, a laptop computer, and so on. The control message generated by the source device may be a BLE advertising message. Electronic display bands that receive the BLE advertising message that includes the control message (e.g., that includes a command to display a message and/or to output a particular light pattern) may modify the received BLE advertising message and then re-broadcast or echo the modified version of the BLE advertising message to other electronic display bands and/or other electronic display devices. Those other electronic display bands may receive the BLE advertising message, modify the received BLE advertising message (e.g., by incrementing a value that represents a number of electronic display devices the BLE advertising message has passed through) and then re-broadcast or echo the modified version of the BLE advertising message to other electronic display bands and/or other electronic display devices.

Alternatively, the control message generated by the source device may be another type of BLE message such as a BLE characteristic declaration message and/or a characteristic value declaration message. A first electronic display band or set of electronic display bands may act as gateways to the bi-directional wireless mesh network in some embodiments. Such an electronic display band (or set of electronic display bands) may receive, from the source device, the BLE characteristic message and/or BLE characteristic value declaration message that includes the message to be displayed and/or the light pattern to be displayed. The electronic display band(s) may then translate the BLE characteristic declaration message and/or BLE characteristic value declaration message into a BLE advertising message. The electronic display band(s) may then forward the BLE advertising message containing the message to display and/or light pattern to display to other nearby electronic display bands (and/or other electronic display devices). Electronic display bands that receive the BLE advertising message that includes the control message (e.g., that includes a command to display a message and/or to output a particular light pattern) may modify the received BLE advertising message and then re-broadcast or echo the modified version of the BLE advertising message.

Latency and distance are two important requirements which affect the firmware design of the electronic display bands. The electronic display bands are configured to implement the bi-directional wireless mesh network in a manner that minimizes latency over a very large area in embodiments. The low latency is important to achieve to enable the electronic display bands to maintain synchronization across even large areas in embodiments. The wireless mesh network achieves at most a 0.5 second latency over a distance of approximately 400 meters in embodiments. In contrast, existing Bluetooth mesh network implementations are not able to achieve such low latency values, and thus cannot maintain synchronization between multiple members of the wireless mesh network at large distances. Existing Bluetooth Mesh network implementations therefore do not work, for example, for applications such as coordinated light displays and/or message displays at concerts. For example, the Bluetooth mesh specification requires a minimum 100. Ms between retransmissions of an advertisement protocol data unit (PDU). Accordingly, the low latency requirements of some applications such as light shows at concert venues cannot be met using traditional Bluetooth mesh.

In embodiments, the message structure for the bi-directional wireless mesh network includes three distinct layers. These three layers include a mesh layer, a message layer (also referred to as a command layer) and a security layer (also referred to as an encryption layer). The mesh layer deals with making sure that transmitted control messages are distributed quickly and efficiently throughout the bi-directional wireless mesh network. The message layer manages the actual commands sent over the wireless mesh network to be processed by the individual electronic display bands. The security layer authenticates the messages (makes sure they were created by an authorized source device) and makes it difficult for third parties to create their own messages.

All of the control messages (referred to as protocol data units (PDUs)) sent may be composed of non-connectable undirected advertising messages in embodiments. The length of the PDU is variable according to the specific control message. The PDUs are structured to maximize the number of available bytes in the PDU. The PDU may have a maximum length of 27 Bytes if device discovery is enabled. Traditionally BLE uses three bytes for device discovery in packets. In one embodiment, the size of the PDUs may be increased by three additional bytes by using a non-discoverable mode and omitting the flags and their triplet associated with device discovery. This frees up the three bytes that are generally used for device discovery. Accordingly, when all of the available bytes are used for a control message, the control message may have a length of 30 bytes in some embodiments. An example advertising PDU is set forth below.

| 1B | 1B | 2B | up to 27B |
|---|---|---|---|
| Length | Type | Company | Mesh + Msg + Security |
| 3 + Max 27 | 0xFF | 0x000D | 2B . . . 2B? |

As shown, the first Byte in the advertising PDU may indicate a length of the PDU. In one embodiment, the 1B length of the length field is not included in the advertising PDU, freeing up an additional Byte for a remainder of the advertising PDU. As shown, the second Byte of the PDU identifies a device type, which may be manufacturer specific data. The third and fourth Bytes of the advertising PDU may identify a company identifier or code. The remaining Bytes of the advertising PDU include the body of the control message, which includes data for the mesh layer, data for the message layer, and data for the security layer.

The mesh layer is part of every advertising PDU sent on the network and by the source device. The mesh layer may include two Bytes of data in embodiments. An Example of the mesh layer is provided below.

| | |
|---|---|
| 1^{st} Byte | 2nd Byte |

| Bits | Bits | Bit | Bits | Bits |
|---|---|---|---|---|
| 0 . . . 3 | 4 . . . 5 | 6 | 7 | 8 . . . 15 |
| TTL | Type | TBD | Special | Message counter |

The first four bits of the mesh layer may include a time-to-live (TTL) value. The TTL value indicates the time to live for the advertising PDU, and helps trace the max number of hops for which the control message will exist. The source device may set this value according to the maximum range (e.g., maximum TTL (MaxTTL)) and this value is reduced with every long range repetition of the message. Accordingly, each electronic display band that receives an advertising PDU may reduce the TTL value by 1, and then re-broadcast the advertising PDU with the reduced TTL value. If the TTL value is reduced to 0, then the control message is no longer re-broadcast.

The second two bits of the mesh layer may indicate a type, which may identify a type of broadcast and/or a type of broadcaster. The numbering in the below table indicates which transmission event a control message was advertised in (not counting transmissions on different channels) in accordance with one embodiment.

| Type value | Meaning |
|---|---|
| 0x0 | 1st transmission of message sent by source device/echoer |
| 0x1 | 2nd (or middle most) transmissions of messages |
| | sent by source device/echoer |
| 0x2 | Last transmission of message sent by source device/echoer |
| 0x3 | Currently not defined. |

The term echoer may refer to an electronic display band that rebroadcasts or echoes a control message (e.g., an advertising PDU containing a control message).

In one embodiment, the seventh bit of the mesh layer is a “special” bit. The special bit may indicate that the mesh layer needs to consider more bytes from the rest of the message. This may be used for synchronizing the timing of the display of messages and/or light displays by electronic display bands. If the “special” bit is set, then the mesh layer will add a time offset for when the message and/or light pattern is to be displayed by an electronic display band. The amount of time offset may be based on the TTL value in an embodiment. For example, if the TTL value is 5, then the electronic display band receiving the advertising PDU containing the control message may wait the amount of time that it takes for 5 rebroadcasts of the advertising PDU before displaying a message and/or light pattern included in the control message of the advertising PDU. The advertising PDU would have a TTL value of 4, and would wait the amount of time that it takes for 4 rebroadcasts of the advertising PDU before displaying the message and/or light pattern, and so on. Each electronic display band which receives the advertising PDU may add a time offset for each echoing or between new advertising events. This offset may be added to a known position in the message which will not be encrypted. Accordingly, all electronic display bands may display the message and/or light pattern in a synchronized manner.

The second Byte of the mesh layer may include a message counter. The message counter value may increment for each new message sent by the source device. The counter will overflow and restart after 256 messages in some embodiments, but the messages should be distant enough for the counter to be used to distinguish messages already encountered by the source device and/or electronic display bands.

The mesh layer distributes the messages between the electronic display bands within the required latency. Some of the electronic display bands (nodes of the mesh network) will “echo” messages if the electronic display band is at the edge of the broadcast range and the message is the first transmission event and first time the electronic display band has received this message. Echoing such a message means starting a new hop (decrementing TTL) and re-broadcasting the message. This should happen statistically (random according to the number of nodes per hop) only on part of the nodes that meet this condition. After a first message is echoed by a source device or electronic display band, a second message may be received from the source device. Second messages may or may not be echoed. If a second message is to be echoed, a timer will wait up to 100 Msec for a last message if it didn't arrive and the message was not received it may also be echoed. A last event will be echoed if this message was not yet received.

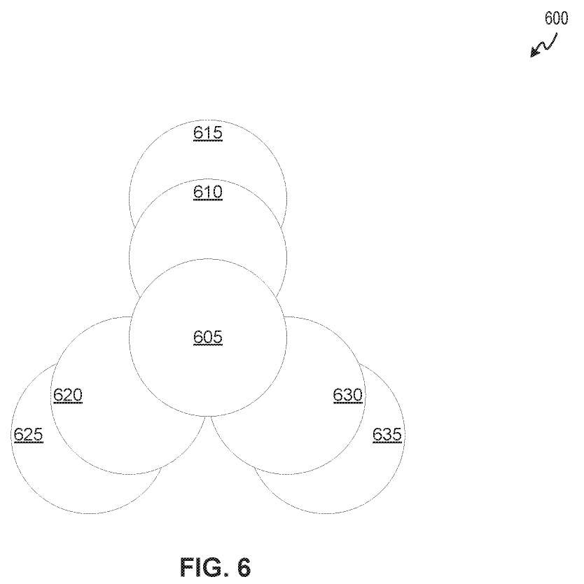

FIG. 6 illustrates multiple different areas of a mesh network and the distribution of a control message between the areas. As shown, three hops are performed of the control message. Each of the different hops may include more than one electronic display band that are designed as echoers in order for the control message to reach all of the areas. The center area 605 represents the distribution of the message sent by the source device. Areas 610, 620 and 630 represent a first hop from the center area 605. Areas 615, 625 and 635 represent a second hop. Area 615 is a second hop from area 610, area 625 is a second hop from area 620, and area 635 is a second hop from area 630. If an electronic display band (e.g., an echoer) receives a copy of a control message it already broadcast (echoed) with a higher TTL value, it will stop broadcasting this control message.

It can be useful for the source device to be located within range of at least a few dozen electronic display bands in some instances. In one embodiment, the source device will send out two different messages separated by a second or less. The source device should have a total of three advertising events for each message in an embodiment. Each event includes changing the type bits accordingly.

During an initialization phase, initial messages are sent by a source device to selected nodes (turning only these on and placing them close to the source device). The source device will set the TTL for the initial messages to 0 and during this phase will repeat at least 10 advertising events for each message sent. The source device should also set the transmit power level to minimum in some embodiments. The initialization messages may include the cryptographic keys, different parameters like MaxTTL, number of nodes, max distance, identifier (ID), etc.

As discussed above, the mesh network includes a message layer. Actual commands and their parameters are processed in the message layer. The general structure of a message in the message layer structure is set forth below.

| | | | | |
|---|---|---|---|---|
| IB | 0 . . . X B | 0 . . . Y B | . . . | . . . |
| OP code | [Parameter] | [Parameter] | [Parameter] | . . . |

Each Op code/cmd determines the form and the number and length of parameters.

Initialization messages for the message layer should be sent once at initialization phase. There may be multiple advertising events for the initialization messages. Other messages may also be sent at this phase.

| Op | | | Bytes per | Total |
|---|---|---|---|---|
| code | Cmd name | Parameters | parm | bytes |
| 0x00 | Not used. | non | 0 | 1 |
| 0x01 | Assign ID | ID | 4 | 5 |
| 0x02 | Sync time | mSecTime | 4 | 5 |
| 0x03 | Init Params | MaxTTL, | 1, 4 | 6 . . . |
| | | #Nodes, | | |
| | | . . . TBD | | |
| 0x04 | SetCryptoKey | keyType, | 1, 16 | 18 |
| | | Key | | |
| 0x05 | TBD | | | |
| 0x06 | TBD | | | |

The same ID may be assigned to multiple nodes. ID may also be assigned (e.g., sequentially assigned) at production phase or later. If the ID for an electronic display band is changed, selector messages may be resent.

Various types of messages that may be included in the message layer for a control message (e.g., advertising PDU) are set forth below.

| Messages may | | | | |
|---|---|---|---|---|
| also be sent | | | | |
| during initial- | | | | |
| ization phase. | | | Bytes per | Total |
| Op code | Cmd name | Parameters | parm | bytes |
| 0x07 | Set Selector | Selector, | 1, 4, 4 | 10 |
| | | Starting ID, | | |
| | | Ending ID | | |
| 0x08 | UnSet Selector | Selector, | 1, 4, 4 | 10 |
| | | Starting ID, | | |
| | | Ending ID | | |
| 0x09 | RGB start | Selector, | 1, 1, 1, 1 | 5 |
| | TBD | R | | |
| | | G | | |
| | | B | | |
| 0x0A | RGBPattern | Selector, | 1, . . . | . . . |
| | | TBD | | |
| 0x0B | StopRGB | Selector | 1 | 2 |
| 0x0C | ReSync | RelativeTime, | | |
| | TBD | TBD | | |
| 0x0C | DisplayText | Selector, | 1, 1 | 3 |
| | | TextNum | | |
| 0x0D | StopText | Selector | 1 | 2 |
| 0x0F | SetTextFull | Selector, | 1, 1, 1, 18 | 22 |
| | | Pos, | | |
| | | TextPointer, | | |
| | | Text | | |
| 0x10 | SetText00 | Selector, | 1, 21? | 23? |
| | | Compressed | | |
| | | text | | |
| 0x11 | SetText01 | Selector, | 1, 21? | 23? |
| | | Compressed | | |
| | | text | | |
| . . . | . . . | Selector, | 1, 21? | 23? |
| | | Compressed | | |
| | | text | | |
| 0x1A | SetText10 | Selector, | 1, 21? | 23? |
| | | Compressed | | |
| | | text | | |
| 0x1B | SetDispText | Selector, | 1, 21? | 23? |
| | UnSaved | Compressed | | |
| | | text | | |

The selector property represents a group of ID's. Multiple ID's may be defined for each selector. Multiple selectors may contain similar ID's. The set selector message may contain an ID range. If the starting ID is equal to the ending ID, it means a single ID is used. Selector messages may be sent at all times. For example, if a lottery wants to pick just one ID at random and send it a message, it may simply add a set selector to its ID before sending the message.

Text may be compressed. Compressed text may be packed as 3 chars into one byte by squeezing only the printable characters. But since this is the longest message it will be affected by the security layer final decision. Using this message enables a single message to be used for displaying text, but that single message will have fewer possible characters (e.g., about 63 characters).

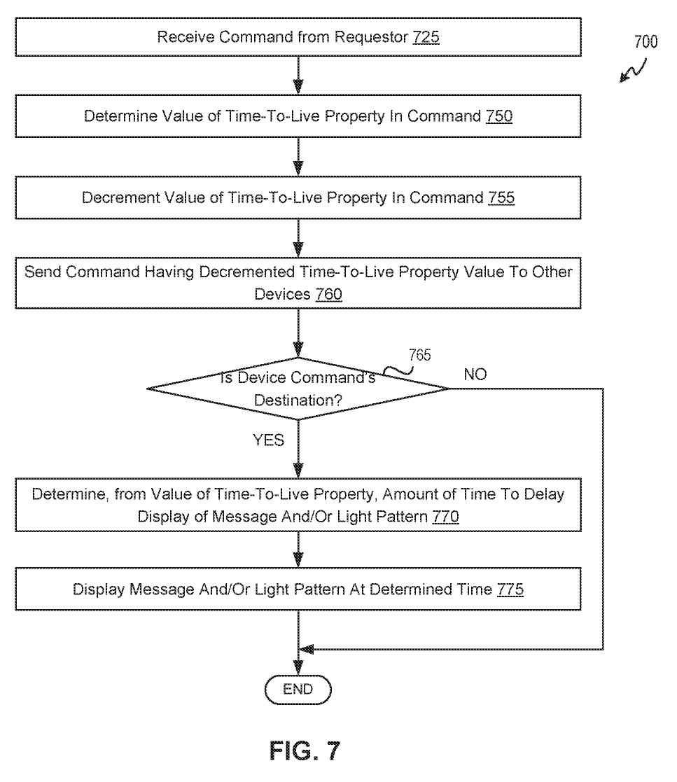

FIG. 7 is a flow chart of an embodiment of a method 700 for synchronizing display of messages and/or light messages between multiple devices in a mesh network. The methods and each of their individual functions, routines, subroutines, or operations may be performed by processing logic of an electronic display band, mobile computing device, or server computing device executing the method. The processing logic may include hardware, software, firmware, or a combination thereof. For example, processing logic may include a general purpose and/or special purpose processor that executes instructions for performing the methods.

At block 725 of method 700, an electronic display band receives a command from a requestor. The command may be a control message that may include a message to display (e.g., a text message), a light pattern to emit and/or a command to display a message and/or light pattern already stored in a memory of the electronic display band. At block 750, the electronic display band determines a value of a time-to-live property in the received command. The value of the time-to-live property may indicate a number or retransmissions of the command that are to be sent. At block 755, the electronic display band decrements the value of the time-to-live property in the command. At block 760, processing logic sends the command having the decremented time-to-live property value to one or more other electronic display devices.

At block 765, the electronic display band determines if it was a destination for the command (e.g., if the command was addressed to a group that includes the electronic display band). If the electronic display band was not a destination for the command, the method ends. If the electronic display band was a destination for the command, the method continues to block 770.

At block 770, the electronic display band determines, from the value of the time-to-live property, an amount of time to delay a display of the message and/or light pattern. The delay may be determined from the original value of the time-to-live property that the command had on receipt by the electronic display band or from the decremented value of the time-to-live property. At block 775, the electronic display band then displays the message and/or light pattern at the determined time.

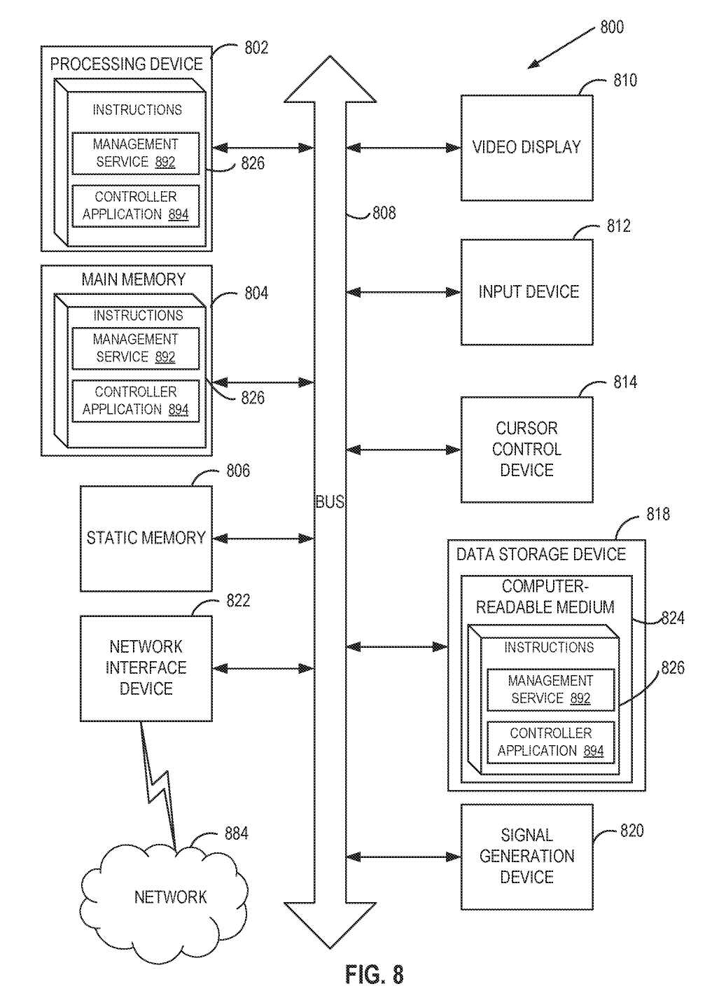

FIG. 8 depicts a block diagram of a computer system operating in accordance with one or more aspects of the present disclosure. In various illustrative examples, computer system 800 may correspond to electronic display bands 310A-C, mobile computing device 326, server computing device 350 and/or computing device 340 of FIG. 3.

In certain implementations, computer system 800 may be connected (e.g., via a network, such as a Local Area Network (LAN), an intranet, an extranet, or the Internet) to other computer systems. Computer system 800 may operate in the capacity of a server or a client computer in a client-server environment, or as a peer computer in a peer-to-peer or distributed network environment. Computer system 800 may be provided by a personal computer (PC), a tablet PC, a set-top box (STB), a Personal Digital Assistant (PDA), a cellular telephone, a web appliance, a laptop computer, a tablet computer, a server computing device, a network router, switch or bridge, an electronic display device, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 800 may include a processing device 802, a main (volatile) memory 804 (e.g., random access memory (RAM)), a static (non-volatile) memory 806 (e.g., read-only memory (ROM) or electrically-erasable programmable ROM (EEPROM)), and/or a data storage device 818, which may communicate with each other via a bus 808.

Processing device 802 may be provided by one or more processing devices such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 800 may further include a network interface device 822 (e.g., a wireless communication module, wireless modem, etc.). Computer system 800 also may include a video display unit 810 (e.g., an LCD), an input device 812 (e.g., a keyboard, touch screen, touchpad, etc.), and a cursor control device 814 (e.g., a mouse).

Data storage device 818 may include a non-transitory computer-readable storage medium 824 on which it may store instructions 826 encoding any one or more of the methods or functions described herein, including instructions encoding methods 400, 500 and/or 700 for controlling electronic display bands. For example, data storage device 818 may include instructions 826 for an electronic device management service 892 and/or an electronic device controller application 894, which may correspond to similarly named components described earlier herein.

Instructions 826 may also reside, completely or partially, within main memory 804 and/or within processing device 802 during execution thereof by computer system 800, hence, main memory 804 and processing device 802 may also constitute machine-readable storage media.

While computer-readable storage medium 824 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any non-transitory tangible medium that is capable of storing or encoding a set of instructions for execution by a computer or device that cause the computer or device to perform any one or more of the methods described herein. The term “computer-readable storage medium” shall include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and software components, or only in software.

Unless specifically stated otherwise, terms such as “receiving”, “identifying”, “determining”, “transmitting”, “displaying”, or the like, refer to actions and processes performed or implemented by a computer system that manipulates and transforms data represented as physical (electronic) quantities within the computer system registers and memories into other data similarly represented as physical quantities within the computer system memories or registers or other such information storage or display devices. Also, the terms “first,” “second,” “third,” “fourth,” etc. as used herein are meant as labels to distinguish among different elements and may not necessarily have an ordinal meaning according to their numerical designation.

Examples described herein also relate to an apparatus for performing the methods described herein. This apparatus may be specially constructed for performing the methods described herein, or it may include a general purpose computer system selectively programmed by a computer program stored in the computer system. Such a computer program may be stored in a computer-readable tangible storage medium.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

What is claimed is:

1. An electronic display band, comprising:
a circuit board;
a plurality of components mounted to the circuit board, the plurality of components comprising:
one or more battery;
one or more integrated circuits;
a first plurality of light emitting elements arranged in a grid;
a second plurality of light emitting elements; and
a first wireless module comprising a radio, wherein the first wireless module is configured to implement a bi-directional wireless mesh network using the radio.

2. The electronic display band of claim 1, wherein the first wireless module comprises a Bluetooth adapter and the bi-directional wireless mesh network comprises a Bluetooth mesh network.

3. The electronic display band of claim 1, wherein the first plurality of light emitting elements comprise a first plurality of light emitting diodes (LEDs) and the second plurality of light emitting elements comprise a second plurality of LEDs, and wherein the second plurality of LEDs comprise multi-colored LEDs that are rated to emit light at a higher intensity than the first plurality of LEDs.

4. The electronic display band of claim 1, wherein the radio is an only radio of the first wireless module, and wherein the first wireless module is configured to concurrently receive data at a first frequency range using the radio and to second at least one of the data or additional data at a second frequency range using the radio.

5. The electronic display band of claim 1, wherein the one or more integrated circuits are further to:
receive a command to display a message via the first wireless module, wherein the command is addressed to one or more groups in a group hierarchy;
determine whether the electronic display band is a member of the one or more groups;
display the message responsive to determining that the electronic display band is a member of the one or more groups; and
send the command to one or more additional electronic display bands that are connected to the electronic display band via a mesh network.

6. The electronic display band of claim 5, wherein the one or more integrated circuits are further to:
determine a value of a time-to-live property in the command, wherein the time-to-live property represents a number of rebroadcasts of the command to be made;
determine, from the value of the time-to-live property, an amount of time to delay the display of the message, wherein the message is displayed after the amount of time; and
decrement the value of the time-to-live property before sending the command to the one or more additional electronic display bands.

7. The electronic display band of claim 5, wherein the command is received as an advertising message and is received over an advertising channel of a wireless protocol implemented by the radio.

8. The electronic display band of claim 5, wherein the command is received as a characteristic declaration message, wherein the one or more integrated circuits are to translate the characteristic declaration message comprising the command into an advertising message comprising the command, and wherein the command sent to the one or more additional electronic display bands is sent as the advertising message.

9. The electronic display band of claim 5, wherein the display of the message by the one or more integrated circuits is synchronized with display of the message by the one or more additional electronic display bands.

10. The electronic display band of claim 1, wherein the bi-directional wireless mesh network comprises a latency of less than 0.5 seconds for a distance of approximately 400 meters.

11. The electronic display band of claim 1, wherein the bi-directional wireless mesh network comprises a mesh layer, a message layer and a security layer, wherein the mesh layer distributes commands between nodes of the bi-directional wireless mesh network within a required latency, wherein the message layer processes the commands, and wherein the security layer authenticates the commands.

12. A method comprising:
receiving, by an electronic display band, a command to display a message, wherein the command is addressed to one or more groups in a group hierarchy;
determining, by the electronic display band, whether the electronic display band is a member of the one or more groups;
displaying, by the electronic display band, the message responsive to determining that the electronic display band is a member of the one or more groups; and
sending, by the electronic display band, the command to one or more additional electronic display bands that are connected to the electronic display band via a mesh network.

13. The method of claim 12, further comprising:
determining a value of a time-to-live property in the command, wherein the time-to-live property represents a number of rebroadcasts of the command to be made; and
determining, from the value of the time-to-live property, an amount of time to delay the display of the message, wherein the message is displayed after the amount of time.

14. The method of claim 13, further comprising:
decrementing the value of the time-to-live property before sending the command to the one or more additional electronic display bands.

15. The method of claim 12, wherein the mesh network comprises a mesh layer, a message layer and a security layer, wherein the mesh layer distributes commands between nodes of the mesh network within a required latency, wherein the message layer processes the commands, and wherein the security layer authenticates the commands.

16. The method of claim 12, wherein the mesh network comprises a latency of less than 0.5 seconds for a distance of approximately 400 meters.

17. The method of claim 12, wherein the command is received as a characteristic declaration message, the method further comprising:
translating the characteristic declaration message comprising the command into an advertising message comprising the command, wherein the command sent to the one or more additional electronic display bands is sent as the advertising message.

18. A non-transitory computer readable medium comprising instructions that, when executed by an electronic display device, cause the electronic display device to perform operations comprising:
receiving, by the electronic display device, a command to display a message, wherein the command is addressed to one or more groups in a group hierarchy;
determining, by the electronic display device, whether the electronic display device is a member of the one or more groups;
displaying, by the electronic display device, the message responsive to determining that the electronic display device is a member of the one or more groups; and
sending, by the electronic display device, the command to one or more additional electronic display devices that are connected to the electronic display device via a mesh network.

19. The non-transitory computer readable medium of claim 18, the operations further comprising:
determining a value of a time-to-live property in the command, wherein the time-to-live property represents a number of rebroadcasts of the command to be made; and
determining, from the value of the time-to-live property, an amount of time to delay the display of the message, wherein the message is displayed after the amount of time.

20. The non-transitory computer readable medium of claim 18, wherein the mesh network comprises a latency of less than 0.5 seconds for a distance of approximately 400 meters.
